(19) United States
(12) Patent Application Publication
(10) Pub. No.: US 2008/0260977 A1
(43) Pub. Date: Oct. 23, 2008

(54) Decorative sleeving used in event decorating

(76) Inventors: Mary Michele Finch, Cedar Rapids, IA (US); Rhonda Denise Meek, Cedar Rapids, IA (US)

Correspondence Address: Mary Michele Finch, 1708 26th Street NW, Cedar Rapids, IA, 52405, US

(21) Appl. No.: 12/082,798

(22) Filed: Apr. 14, 2008

Related U.S. Application Data
(60) Provisional application No. 60/923,780, filed on Apr. 17, 2007.

(51) Int. Cl. B29D 23/00

(52) U.S. Cl. 428/35.5

(57) ABSTRACT

Disposable, flexible, decorative sleeving with a consistent diameter and two open ends. The sleeving is adapted to cover a pole, series of poles or other suitable framing used in event decorating.

### CROSS REFERENCES TO RELATED APPLICATIONS

This application claims priority to, and the benefit of, U.S. Provisional Application Ser. No. 60/923,780 filed Apr. 17, 2007, which is hereby incorporated by reference.

### BACKGROUND OF THE INVENTION

This invention relates to decorating for events. In particular, to quickly, economically and easily cover poles used for decorating dance floors, making canopies or other decorative uses. The invention can also be used to cover framing of various sizes used for screening or other decorations at events. It also quickly, completely, and easily covers string lighting or electrical cords used in event decorating.

Events such as weddings, parties, anniversaries, graduations, proms, etc., are an important part of social life. Poles, usually rented, are often used to define dance floors or walkways at events, to screen or highlight certain areas or to make temporary canopies or head table décor. These unsightly poles need to be covered and in the past the only thing available has been fabric, or long plastic sheeting.

The problems with using fabric are numerous:
AVAILABILITY: It is often difficult to find hundreds of yards of matching fabric.
EXPENSE: Fabric is very expensive and therefore not considered disposable.
DIFFICULT APPLICATION:
   Fabric must be hemmed to prevent fraying
   It must be pinned, twisted around, or otherwise draped, to completely cover poles.
   Holes, placed in the fabric to access electrical cords, ruin the fabric and often fray.
   Fabric is often very heavy and difficult to transport.
   Fabric soils easily and must be laundered, ironed and stored after each use.
      There are also problems using long plastic sheeting to cover poles:
DIFFICULT APPLICATION
   Plastic sheeting must be pinned, twisted around, taped or otherwise difficultly draped to completely cover poles.
   String lights or other cords are difficult to cover without repeatedly twisting the plastic sheeting over and over the cords. This is extremely cumbersome.
      Our invention has removed all these obstacles.

### SUMMARY OF THE INVENTION

The invention creates a novel use for an existing product. Blown film or other non-woven, plastic polymer type sleeving, whether seamed or not, is used to make bags or other products in the plastics industry. The embodiment of the invention is a length of plastic sleeving with a consistent diameter from end to end. The plastic polymer flexible sleeving is inexpensive, thus disposable and recyclable. It can be made in many colors and sheens. A long length of the sleeving is rolled on a core to prevent wrinkling and placed in a box, which is easy to transport to an event. There is never any fraying when the product is cut, or when holes are placed in the sleeving to access electrical cords. The sleeving can come in various diameters depending on its use. In the case of covering poles, the diameter is large enough to provide generous draping and to be easy to work with. The sleeving can be quickly unrolled, cut to the desired length and slipped over a pole. Because it is sleeving, there is no need to twist around, pin or tape things in place to completely cover the pole. Simply twist tie, knot, or otherwise close the sleeving at the top of the pole to hold it in place. A length of sleeving can be cut to cover one pole, or a pole and the distance between it and an adjacent pole. String lights or other lighting cords can be run through the sleeving between the poles. All of this is completely hidden because it is in a sleeve. There are absolutely no gaps. Holes can quickly and easily be put into the sleeving allowing access to electrical cords.

The sleeving can also be available in large diameters making it the perfect item to slip over framing as a decorative element to divide, screen, or highlight an area, or for advertising.

### BRIEF DESCRIPTION OF THE DRAWINGS

FIG. 1 is a perspective view of an embodiment of the invention showing a roll of sleeving partially unrolled.

FIG. 2 is the same view as FIG. 1 with the end of the sleeving opened up to show its diameter.

FIG. 3 is a perspective view of a section of sleeving that has been cut from the roll and is opened up, ready to use.

FIG. 4 is a perspective view of a pole ready to be covered.

FIG. 5 is a perspective view of FIG. 4, now covered with the sleeving, twisted-tied at the top to hold it in place.

FIG. 6 is a perspective view of several poles, along with string light, being covered with the sleeving.

FIG. 7 is a perspective view of two poles, along with string lights, being covered with a length of large diameter sleeving.

### DETAILED DESCRIPTION OF THE INVENTION

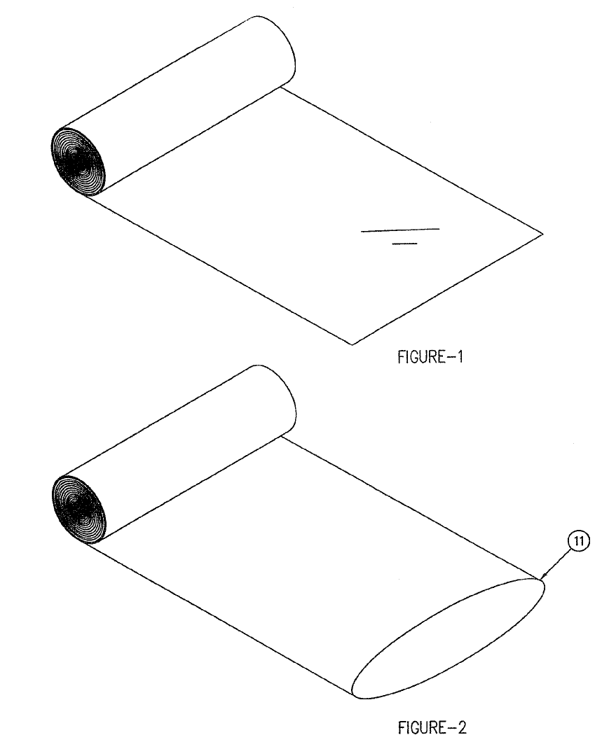

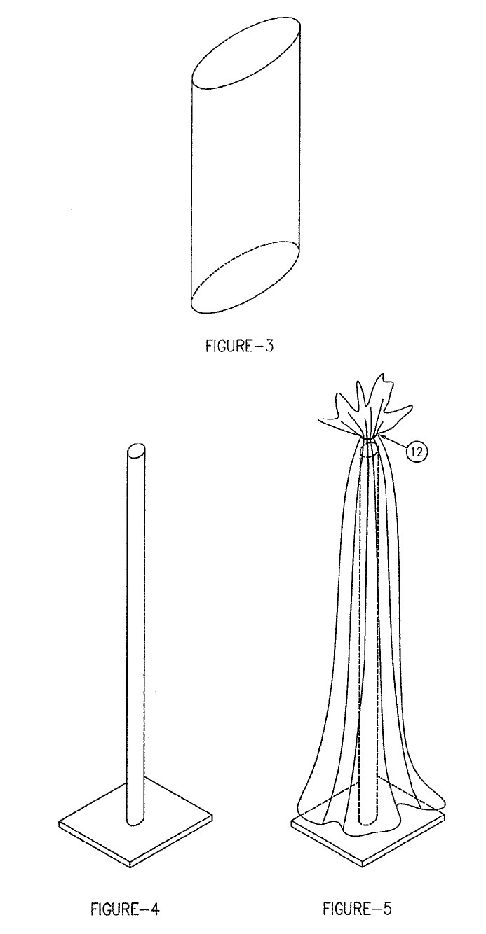

As seen in FIGS. 1-2, the invention comprises plastic type polymer, non-woven sleeving. In FIG. 2, the end of the sleeving is opened up (11) to show the diameter of the sleeving. FIG. 3 shows a length of the sleeving, cut off the roll, opened up and ready for use.

FIG. 4 shows a typical pole used in event decorating. FIG. 5 is a view of the same pole, now covered with the sleeving. The sleeving at the top of the pole is closed with a twist-tie (12) to keep the sleeving in place.

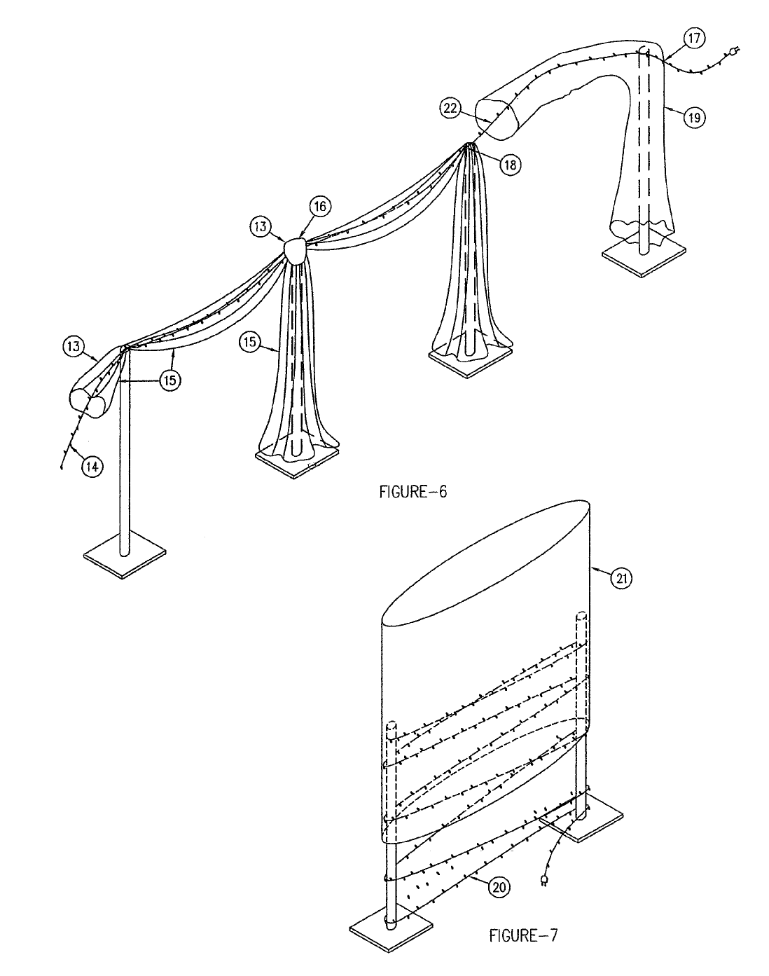

FIG. 6 shows a preferred method of covering a series of four poles and string lights (14), with the sleeving. This would be a typical use for a dance floor or walkway. A length of sleeving covers one pole (15) along with the space between it and the pole to the left of it. There is excess sleeving (13) on the top of the pole to the left.

The sleeving is slipped over a pole (19) and string lights are channeled through the sleeving (22). A hole (17) is placed in the sleeving to allow access to the string lights. The excess sleeving (13) is used to loop around the top of the adjacent covered pole (16). The sleeving at the top of each pole can be twist-tied (18) to hold it in place.

FIG. 7 shows a wide diameter embodiment of sleeving (21) being slipped over two poles decorated with string lights (20).

In one embodiment, the plastic polymer sleeving may be manufactured in different colors. In some embodiments, the plastic polymer sleeving may be printed with names, logos, and/or holographic images to customize and personalize their appearance.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included within the scope of the following claims.

What is claimed is as follows:

1. Disposable, flexible, decorative sleeving adapted to cover a pole, series of poles, or other suitable framing used in event decorating. Said sleeving comprising:
Plastic polymer or other non-woven material sleeving, whether seamed or blown film, with two open ends.

2. The decorative sleeving of claim one, where said sleeving has a consistent diameter from one open end to the other open end.
